(19) United States
(12) Patent Application Publication
(10) Pub. No.: US 2007/0164931 A1
(43) Pub. Date: Jul. 19, 2007

(54) Plasma display panel

(76) Inventor: Yoshinori Miyazaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/652,609

(22) Filed: Jan. 12, 2007

(30) Foreign Application Priority Data
Jan. 13, 2006 (JP) 2006-006324

(51) Int. Cl. G09G 3/28

(52) U.S. Cl. 345/63

(57) ABSTRACT

A plasma display panel according to the present invention is a plasma display panel including a screen with plural display lines, comprising a temperature detector which detects a temperature of at least a portion of the plasma display panel, and a display data adjustor which adjusts a line display data for one of the plural display lines, based on the detected temperature and information generated from each of the line display data.

### CROSS-REFERENCE TO RELATED APPLICATIONS

This application is based upon and claims the benefit of priority from the prior Japanese Patent Application No. 2006-006324, filed on Jan. 13, 2006, the entire contents of which are incorporated herein by reference.

### BACKGROUND OF THE INVENTION

1. Field of the Invention

The present invention relates to a plasma display panel.

2. Description of the Related Art

A plasma display panel sometimes has a luminance difference between plural display lines even of the same display data. The luminance difference between the display lines is fundamentally caused by voltage drop on an electrode caused by sustain current at the time of discharging light emission. Generally, the luminance difference is attempted to be reduced by reducing impedance of the electrode, by reducing impedance of a driving circuit, and the like. However, it is impossible to completely eliminate the luminance difference and the luminance difference reduction is limited.

Further, the luminance difference is caused by a line display load factor. The line display load factor is a display load factor for a single display line. It depends on the number of lit cells in a single display line and a gray scale of the lit cells. When the line display load factor is high, a large current flows in a pair of electrodes, causing a large voltage drop. As a result, the luminance decreases largely. On the contrary, when the line display load factor is low, a small current flows in a pair of the electrodes, causing small voltage drop. As a result, the luminance scarcely decreases. Additionally, there arises the luminance difference between the display lines.

Meanwhile, an approach where the luminance difference between the display lines is eliminated by controlling the number of sustain discharges for each display line is suggested in Patent document 1 (Japanese Patent Application Laid-Open No. Hei 9-68945)

However, the number of pulses of the sustain discharge has to be controlled for the each sustain electrode and an exclusive driving circuit is required and the number of pulses of the sustain discharge is needed to be calculated every line to supply the result to the driving circuit, considering circuit scale and costs not so much. In other words, each of a sustain pulses applied to each of sustain electrode is controlled separately and an extra circuit is needed.

In addition, display data applied to the sustain electrode to display an image on the screen is not controlled in Patent document 1. The control disclosed in Patent Document 1 is only to adjust the number of sustain pulses. Further, the control must be performed for each subfield so as to obtain a sufficient effect. Additionally, the luminance difference caused by temperature is not considered.

### SUMMARY OF THE INVENTION

An object of the present invention is to provide a plasma display panel capable of reducing luminance difference between display lines.

A plasma display panel according to the present invention is a plasma display panel including a screen with plural display lines, a temperature detector which detects a temperature of at least a portion of the plasma display panel, and a display data adjustor which adjusts a line display data for one of the plural display lines, based on the detected temperature and information generated from each of the line display data.

Further, a plasma display panel according to the present invention is a plasma display panel including plural display lines which displays an image in a single field having plural subfields utilizing display data, a display load factor detector which detects a display load factor of one of the single field and at least some of the subfields included in the single field, and a display data adjustor which adjusts a line display data for one of the plural display lines, based on the detected display load factor and information generated from each of the line display data.

Additionally, in accordance with the present invention, a plasma display panel includes a screen with plural display lines, an elapsed time detector which detects an elapsed time from the supply of power for the display panel, and a display data adjustor which adjusts a line display data for one of the plural display lines, based on the detected elapsed time and information generated from each of the line display data.

### BRIEF DESCRIPTION OF THE DRAWINGS

FIG. 1 is a view showing an example configuration of a plasma display device according to a first embodiment of the present invention;

FIG. 2 is a view showing an example configuration of a display line luminance difference corrector in FIG. 1;

FIG. 3 is a view showing an example configuration of a gain control unit in FIG. 2;

FIG. 4 is a view showing an example configuration of the display line luminance difference corrector according to a second embodiment of the present invention;

FIG. 5 is a view showing an example configuration of a gamma control unit in FIG. 4;

FIG. 6 is a view showing an example temperature detection of a temperature detector in FIG. 1;

FIG. 7 is a view showing another example temperature detection of the temperature detector in FIG. 1;

FIG. 8 is a view showing an example configuration of a display load factor detecting circuit according to a third embodiment of the present invention;

FIG. 9 is a view showing an example configuration of the display load factor detecting circuit according to a fourth embodiment of the present invention;

FIG. 10 is a view showing an example configuration of a microprocessor and the temperature detector according to a fifth embodiment of the present invention;

FIG. 11 is a graph showing a relation between a line display load factor, a temperature and a gain coefficient;

FIGS. 12A and 12B are graphs showing another relation between the line display load factor, the temperature and the gain coefficient;

FIG. 13 is a graph showing a relation between the line display load factor, a display load factor of a single field and the gain coefficient;

FIG. 14 is a graph showing a relation between the line display load factor, a sustain pulse waveform and the gain coefficient;

FIG. 15 is a graph showing a relation between the line display load factor, deviation of display data in each display line and the gain coefficient;

FIG. 16 is a view showing in detail a plasma display panel, an X-electrode driving circuit, a Y-electrode driving circuit and an address electrode driving circuit in FIG. 1;

FIG. 17 is an exploded perspective view showing an example structure of the plasma display panel in FIG. 16; and

FIG. 18 is a view showing an example configuration of a single field of an image.

### DETAILED DESCRIPTION OF THE PREFERRED EMBODIMENTS

### First Embodiment

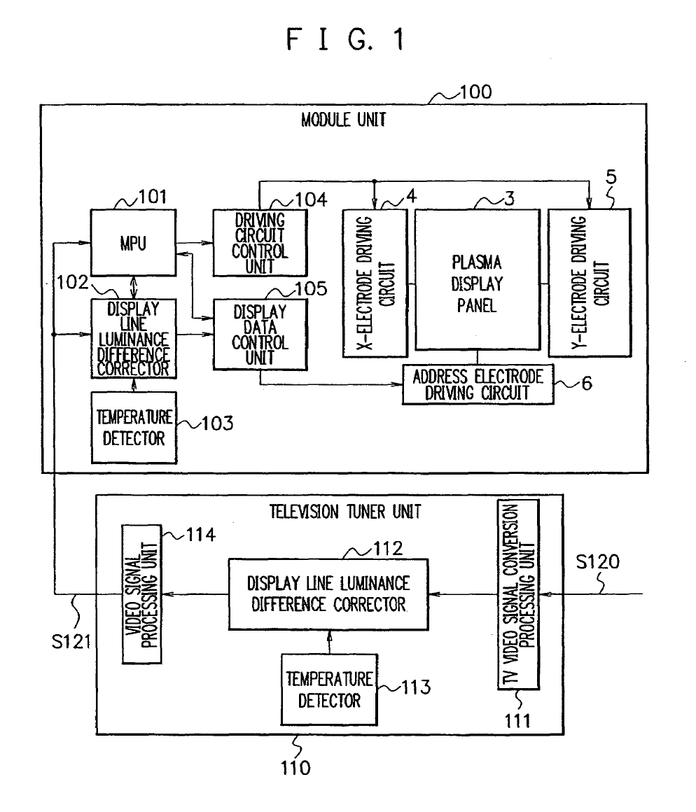

FIG. 1 is a view showing an example configuration of a plasma display device according to a first embodiment of the present invention. When a display line luminance difference corrector 102 and a temperature detector 103 are provided in a module unit 100, a display line luminance difference corrector 112 and a temperature detector 113 in a television tuner unit 110 are not necessary. On the other hand, when the display line luminance difference corrector 112 and the temperature detector 113 are provided in the television tuner unit 110, the display line luminance difference corrector 102 and the temperature detector 103 in the module unit 100 are not necessary. The display line luminance difference corrector 102 and the display line luminance difference corrector 112 have the same configuration, and the temperature detector 103 and the temperature detector 113 have the same configuration.

The television tuner unit 110 includes a TV video signal conversion processing unit 111, a display line luminance difference corrector 112, a temperature detector 113 and a video signal processing unit 114. First, a case having no display line luminance difference corrector 112 and temperature detector 113 will be described. The TV video signal conversion processing unit 111 inputs a TV video signal S120 and converts it into a video signal to be displayed on the plasma display device. The video signal processing unit 114 performs a signal processing with respect to the video signal converted by the TV video signal conversion processing unit 111 to output a video signal S121.

The module unit 100 includes a microprocessor (MPU) 101, the display line luminance difference corrector 102, the temperature detector 103, a driving circuit control unit 104, a display data control unit 105, a plasma display panel 3, an X-electrode driving circuit 4, a Y-electrode driving circuit 5 and an address electrode driving circuit 6.

The microprocessor 101 inputs the video signal S121 thereinto to control the display line luminance difference corrector 102, the driving circuit control unit 104 and the display data control unit 105. The temperature detector 103 detects a temperature. For example, the temperature detector 103 detects the temperature of the plasma display panel 3, the X-electrode driving circuit 4 or the Y-electrode driving circuit 5. The microprocessor 101 outputs a correction coefficient to the display line luminance difference corrector 102 in accordance with the temperature detected by the temperature detector 103 and the display content of each display line. The details thereof will be described later. Note that the correction coefficient may be obtained from any of the microprocessor 101, the display line luminance difference corrector 102 and the display data control unit 105.

The display line luminance difference corrector 102 corrects the video signal S121 in accordance with the correction coefficient to output it to the display data control unit 105. The display data control unit 105 controls the address electrode driving circuit 6 in accordance with the corrected video signal. The driving circuit control unit 104 controls the X-electrode driving circuit 4 and the Y-electrode driving circuit 5.

Next, the case where the display line luminance difference corrector 112 and the temperature detector 113 are provided in the television tuner unit 110 will be described. The temperature detector 113 detects the temperature as in the temperature detector 103. The display line luminance difference corrector 112 corrects the video signal corrected by the TV video signal conversion processing unit 111 in accordance with the temperature detected by the temperature detector 113 and a display content of the each display line to output it to the video signal processing unit 114 as in the display line luminance difference corrector 102.

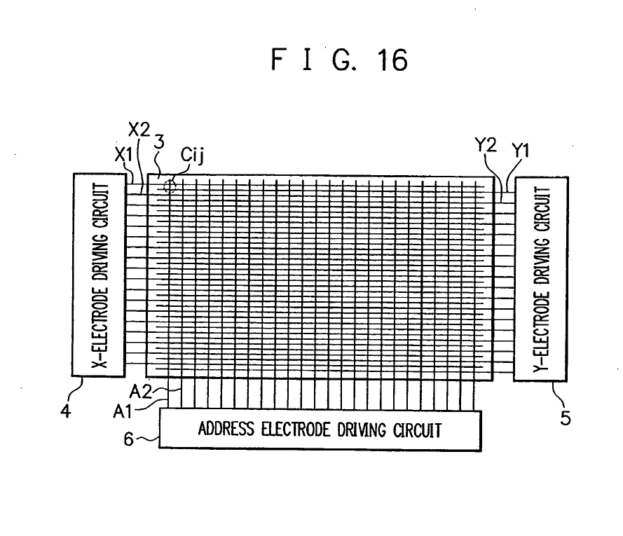

FIG. 16 is a view showing in more detail the plasma display panel 3, the X-electrode driving circuit 4, the Y-electrode driving circuit 5 and the address electrode driving circuit 6 in FIG. 1. The X-electrode driving circuit 4 supplies predetermined voltage to a plurality of the X-electrodes X1, X2, . . . . Hereinafter, each of the X-electrodes, X1, X2, . . . is referred to as or the X-electrodes are collectively referred to as X-electrode(s) Xi, in which “i” represents a subscript. The Y-electrode driving circuit 5 supplies predetermined voltage to a plurality of the Y-electrodes Y1, Y2, . . . . Hereinafter, each of the Y-electrodes, Y1, Y2, . . . is referred to as or the Y-electrodes are collectively referred to as Y-electrode(s) Yi, in which “i” represents a subscript. The address electrode driving circuit 6 supplies predetermined voltage to a plurality of address electrodes A1, A2, . . . . Hereinafter, each of the address electrodes A1, A2, . . . is referred to as or the address electrodes are collectively referred to as address electrode(s) Aj, in which “j” represents a subscript.

In the plasma display panel 3, the Y-electrodes Yi and the X-electrodes Xi form lines extending in parallel in the horizontal direction, and the address electrodes Aj form columns extending in the vertical direction. The Y-electrode Yi and the X-electrode Xi are disposed alternately in the vertical direction. The Y-electrodes Yi and the address electrodes Aj form two-dimensional matrix of i lines and j columns. A display cell Cij is formed by a cross point of the Y-electrode Yi and the address electrode Aj and the X-electrode Xi adjacent thereto in a corresponding manner thereto. The display cell Cij corresponds to a pixel, so that the plasma display panel 3 can display a two-dimensional image.

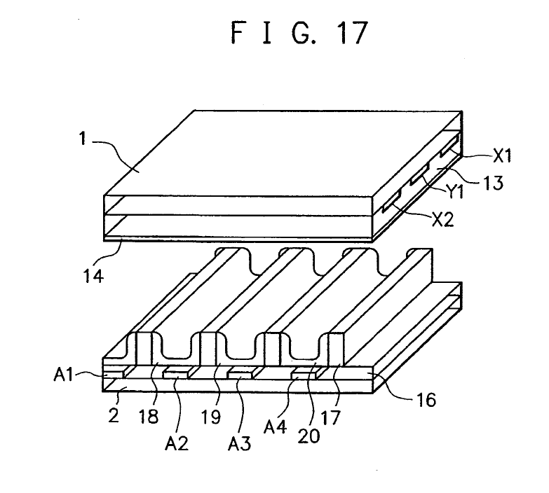

FIG. 17 is an exploded perspective view showing an example structure of the plasma display panel 3. The X-electrode Xi and the Y-electrode Yi are formed on a front-face glass substrate 1. A dielectric layer 13 to insulate from a discharge space is deposited thereon. An MgO (magnesium oxide) protective layer 14 is deposited further thereon. Meanwhile, the address electrode Aj is formed on a rear-face glass substrate 2 disposed to face the front-face glass substrate 1. A dielectric layer 16 is deposited thereon. Phosphors 18 to 20 are deposited further thereon. Inside ribs 17, the phosphors 18 to 20 of red, blue and green are aligned in a striped manner by being coated for each color. The electric discharge between the X-electrodes Xi and the Y-electrodes Yi excites the phosphors 18 to 20, so that the lights of the respective colors are emitted. In the discharge space between the front-face glass substrate 1 and the rear-face glass substrate 2, Ne—Xe Penning gas or the like is enclosed.

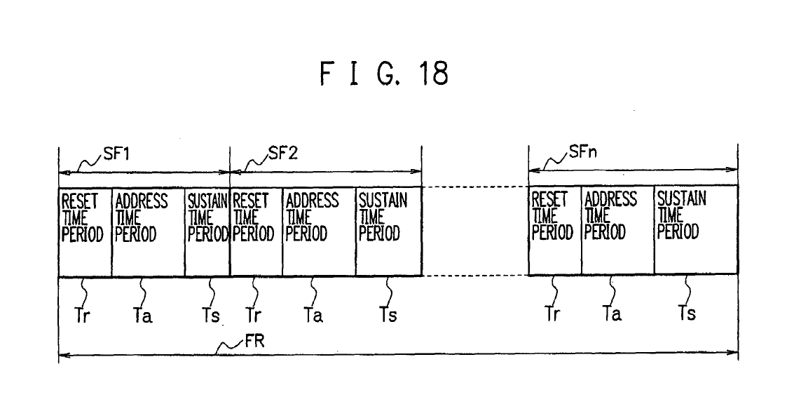

FIG. 18 is a view showing an example configuration of a single field FR of the image. The single field FR is composed of a first subfield SF1, a second subfield SF2, . . . , and an n-th subfield SFn. The “n” is for example “10” and corresponds to the number of tone bits. Hereinafter, each of the subfields SF1, SF2 and the like is referred to as, or the subfields are collectively referred to as subfield(s) SF.

The each subfield SF is composed of a reset time period Tr, an address time period Ta and a sustain (sustain discharge) time period Ts. In the reset time period Tr, the display cell Cij is initialized. In the address time period Ta, the electric discharge is caused between the X-electrode Xi and the Y-electrode Yi by address discharge between the address electrode Aj and the Y-electrode Yi as a pilot flame, allowing the each display cell to choose light emission or non-light emission, respectively. Specifically, scan pulse is applied sequentially to the Y-electrodes Y1, Y2, Y3, Y4, . . . and the like and address pulse is applied to the address electrode Aj in response to the scan pulse, so that the light emission or the non-light emission can be chosen for the desired display cell Cij. In the sustain time period Ts, the light emission is performed by causing sustain discharge between the X-electrode Xi and the Y-electrode Yi of the selected display cell Cij. The number of times of light emissions (length of the sustain time period Ts) caused by the sustain pulse between the X-electrode Xi and the Y-electrode Yi is different for the each subfield SF. Backed by this, the gray scale can be determined.

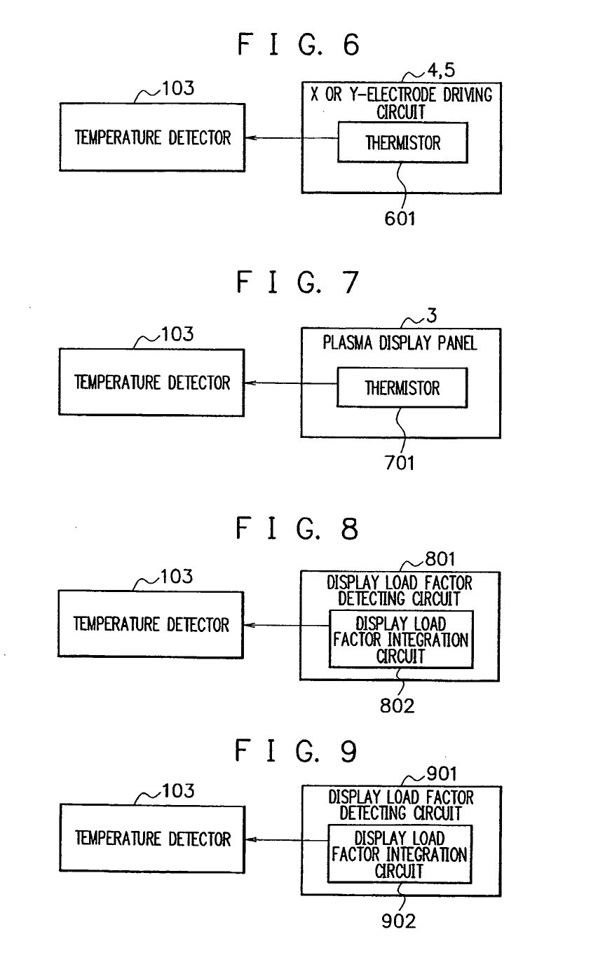

FIG. 6 is a view showing an example temperature detection of the temperature detector 103 in FIG. 1. The X-electrode driving circuit 4 or the Y-electrode driving circuit 5 includes a thermistor 601. In the thermistor 601, a resistance value varies in accordance with the temperature. The temperature detector 103 can detect the temperature of the X-electrode driving circuit 4 or the Y-electrode driving circuit 5 by detecting the resistance value of the thermistor 601.

FIG. 7 is a view showing another example temperature detection of the temperature detector 103 in FIG. 1. The plasma display panel 3 includes a thermistor 701. The temperature detector 103 can detect the temperature of the plasma display panel 3 by detecting the resistance value of the thermistor 701.

As described above, the temperature detector 103 is allowed to detect any temperature of the X-electrode driving circuit 4, the Y-electrode driving circuit 5 or the plasma display panel 3.

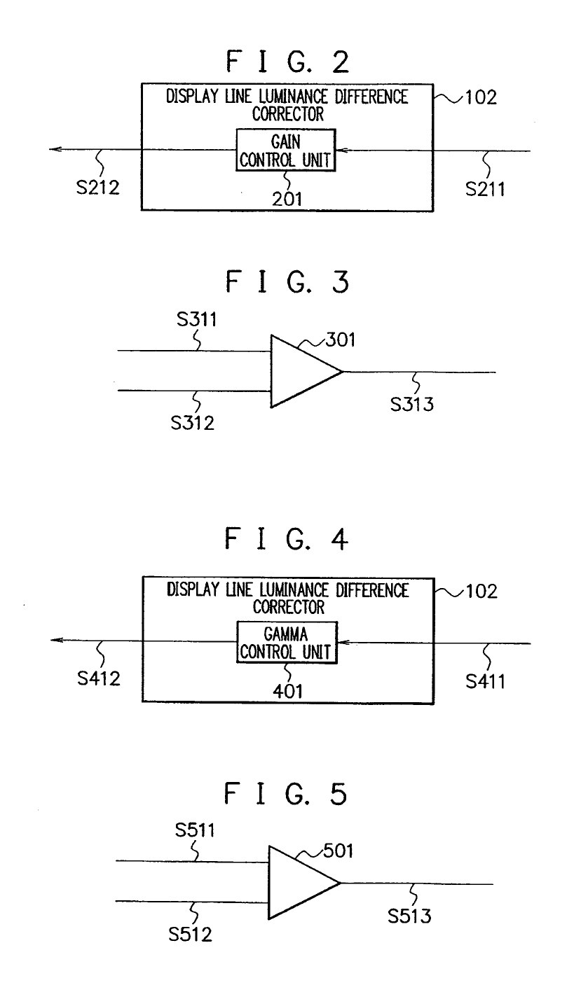

FIG. 2 is a view showing an example configuration of the display line luminance difference corrector 102 in FIG. 1. The display line luminance difference corrector 102 includes a gain control unit 201. The gain control unit 201 controls a gain in input display data (video signal) S211 to output display data S212. Note that the display data S211 corresponds to the display data S121 in FIG. 1.

FIG. 3 is a view showing an example configuration of the gain control unit 201 in FIG. 2. The gain control unit 201 includes a multiplier 301. The multiplier 301 multiplies display data 311 by a correction gain coefficient S312 to output display data S313. The display data S311 corresponds to the display data S211 in FIG. 2, and the display data S313 corresponds to the display data S212 in Fig, 2. The correction gain coefficient S312 is a correction coefficient inputted from the microprocessor 101 in FIG. 1.

FIG. 11 is a graph showing a relation between a line display load factor, the temperature and the gain coefficient. The vertical axis shows the gain coefficient S312 in FIG. 3. The horizontal axis shows the display load factor of the each display line (hereinafter referred to as the “line display load factor”). The display line is the line extending in the horizontal direction in FIG. 16. A characteristic line T25 is that when the temperature detected by the temperature detector 103 is 25° C. A characteristic line T50 is that when the temperature detected by the temperature detector 103 is 50° C. A characteristic line T75 is that when the temperature detected by the temperature detector 103 is 75° C.

Next, the description will be given of the line display load factor. The line display load factor is detected on the basis of the number of pixels emitting light in the single line and the gray scale of the light emitting pixels. For example, when all the pixels in the single line are displayed at the maximum gray scale, the display load factor is 100%. Similarly, when all the pixels in the single line are displayed at a half of the maximum gray scale, the display load factor is 50%. Also, even when only a half (50%) of the pixels in the single line is displayed at the maximum gray scale, the display load factor is 50%.

When the line display load factor is high, large current flows in the X-electrode and the Y-electrode, causing large voltage drop. As a result, the luminance decreases largely. On the contrary, when the line display load factor is low, small current flows in the X-electrode and the Y-electrode, causing small voltage drop. As a result, the luminance scarcely decreases. Backed by this, there arises the luminance difference between the display lines having different line display load factors even in the pixels of the same gray scale. In the present embodiment, when the line display load factor is high, the gain coefficient is increased to increase the luminance to relatively higher. On the contrary, when the line display load factor is low, the gain coefficient is decreased to reduce the luminance to relatively lower. Backed by this, the luminance difference between the display lines can be prevented for the pixels of the same gray scale at the time of the input.

Further, in addition to the above-described line display load factor, the above-described luminance difference between the display lines varies in accordance with the temperature. When the temperature is low, the above-described luminance difference between the display lines is small. On the contrary, when the temperature is high, the above-described luminance difference between the above-described display lines is large. In the present embodiment, when the temperature detected by the temperature detector 103 is low as in the characteristic line T25, the luminance difference between the display lines is small, in which the gain correction is performed in accordance therewith. On the contrary, when the temperature detected by the temperature detector 103 is high as in the characteristic line T75, the luminance difference between the display lines is large, in which the gain correction is performed in accordance therewith.

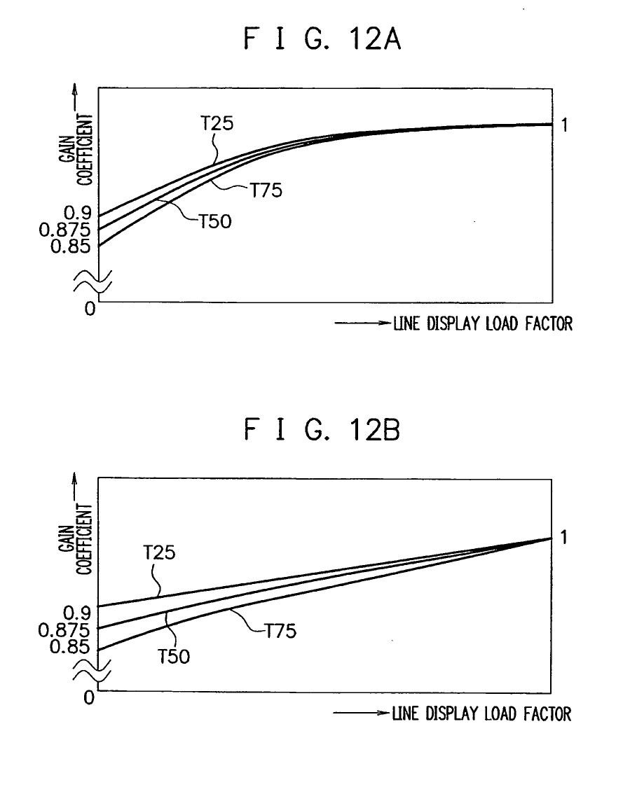

FIGS. 12A, 12B are graphs showing another relations between the line display load factor, the temperature and the gain coefficient. The microprocessor 101 outputs the gain coefficient in accordance with any of the characteristics in FIG. 11 and FIGS. 12A, 12B. When the characteristic in FIG. 11 is used, the display data can be corrected to have a linear characteristic with respect to the line display load factor. Further, when the characteristic in FIG. 12A is used, the display data can be corrected to have a nonlinear characteristic, in which a rate of change per unit of time increases as the temperature increases, with respect to the line display load factor. Furthermore, when the characteristic in FIG. 12B is used, the display data can be corrected to have a changing characteristic from the linear characteristic to the nonlinear characteristic as the temperature increases, with respect to the line display load factor. At this time, needless to say, the nonlinear characteristic shown in FIGS. 12A, 12B may be formed by approximation of a plurality of straight lines, namely a so-called linear-approximation.

As described above, in the present invention, the temperature detector 103 detects the temperature of the plasma display panel 3, the X-electrode driving circuit 4 or the Y-electrode driving circuit 5. The microprocessor 101 calculates the line display load factor based on the display data. As shown in FIG. 11, FIG. 12A or FIG. 12B, in accordance with the detected temperature and the line display load factor, the microprocessor 101 outputs the gain coefficient to the display line luminance difference corrector 102. As shown in FIG. 3, the display line luminance difference corrector 102 multiplies the gain coefficient S312 by the display data S311 to output the corrected display data S313. In other words, the display line luminance difference corrector 102 corrects the display data by controlling the gain in the display data in accordance with the gain coefficient S312. Backed by this, even when the temperature and the line display load factor are different, the luminance difference between the display lines can be prevented as long as they are of the pixels having the same gray scale.

### Second Embodiment

FIG. 4 is a view showing an example configuration of the display line luminance difference corrector 102 according to a second embodiment of the present invention. Hereinafter, the description will be given of difference between the present embodiment and the first embodiment. The display line luminance difference corrector 102 includes a gamma control unit 401. The gamma control unit 401 gamma-corrects input display data S411 to output display data S412. The gamma correction corrects the display data in accordance with a gamma value of the display device in that the luminance of the display device changes not in direct proportion to the input voltage but exponentially thereto.

FIG. 5 is a view showing an example configuration of the gamma control unit 401 in FIG. 4. The gain control unit 401 includes a multiplier 501. The multiplier 501 multiplies input display data S511 by a correction gamma coefficient S512 to output display data S513. The display data S511 corresponds to the display data S411 in FIG. 4, and the display data S513 corresponds to the display data S412 in Fig, 4. The microprocessor 101 generates the correction gamma coefficient S512 based on the gain coefficient and the gamma coefficient in FIG. 11, FIG. 12A or FIG. 12B.

As described above, in the present embodiment, at the time of the gamma correction, the correction of the display data in the first embodiment is performed together. Backed by this, as in the first embodiment, even when the temperature and the line display load factor are different, the luminance difference between the display lines can be prevented as long as the pixels has the same gray scale at the time of the input.

### Third Embodiment

FIG. 8 is a view showing an example configuration of a display load factor detecting circuit 801 according to a third embodiment of the present invention. The display load factor detecting circuit 801 is provided in the module unit 100 in FIG. 1 and includes a display load factor integration circuit 802. The display load factor integration circuit 802 calculates the display load factor of a single field based on the display data S121 and performs time integration thereof.

The line display load factor of the single field is detected on the basis of the number of pixels emitting light in the single field (single screen) and the gray scale of the light emitting pixels. For example, when all the pixels in the single field are displayed at the maximum gray scale, the display load factor is 100%. Similarly, when all the pixels in the single field are displayed at a half of the maximum gray scale, the display load factor is 50%. Also, even when only a half (50%) of the pixels in the single field is displayed at the maximum gray scale, the display load factor is 50%.

As the display load factor of the single field increases, larger current flows in the X-electrode and the Y-electrode, so that the temperature increases. In other words, the integrated value of the display load factor of the single field described above can be seen the one expressed by the approximate value to the temperature.

The display load factor detecting circuit 801 outputs the (time-shifting) integrated value of the display load factor of the single field as the approximate value to the temperature to the microprocessor 101 via the temperature detector 103. In comparison with the first embodiment, the present embodiment uses the integrated value of the display load factor of the single field in place of the temperature. The microprocessor 101 outputs the correction coefficient to the display line luminance difference corrector 102, in accordance with the line display load factor and the integrated value of the display load factor of the single field. The display line luminance difference corrector 102 corrects the display data based on the correction coefficient. Backed by this, the luminance difference between the display lines can be prevented.

### Fourth Embodiment

FIG. 9 is a view showing an example configuration of a display load factor detecting circuit 901 according to a fourth embodiment of the present invention. The display load factor detecting circuit 901 is provided in place of the display load factor detecting circuit 801 in FIG. 8 and includes a display load factor integration circuit 902. The display load factor integration circuit 902 calculates the display load factor of a high-order subfield based on the display data S121 and performs time integration thereof.

As shown in FIG. 18, the single field FR includes n pieces of subfields SF1, SF2 to SFn. For example, the subfield SFm corresponds to the gray scale (display data) of 2^{m-1}.

As “m” increases, a sustain pulse number in the sustain time period Ts increases (the sustain time period Ts is extended), in which the number of light emissions by the sustain pulse increases. Only the subfields SF chosen in the address time period Ta emit light. The sum total of the gray scales of the subfields SF that emitted light is the gray scale of the single pixel.

As the subfield SFm has larger “m”, the number of times of current flows flowing in the X-electrode and the Y-electrode increases, so that the temperature increases. In the third embodiment, the integrated value of the display load factor of the single field FR (all the subfields SF) is calculated. However, it is not always necessary to calculate the integrated value of the display load factor of the single field FR (all the subfields SF). Low-order subfield(s) SFm having smaller “m” can be omitted since the number of times of the current flows is small. In other words, the display load factor may be obtained based on the value of a high-order bit of the display data.

The display load factor integration circuit 902 calculates the integrated value of the display load factor only of the high-order subfields SFm of which “m” are a predetermined number or more. In other words, the integrated values of the display load factors are calculated not for all the subfields but for parts thereof. The integrated value of the display load factor of the high-order subfield can be expressed as the approximate value to the temperature as in the third embodiment.

The display load factor detecting circuit 901 outputs the (time-shifting) integrated value of the display load factor of the high-order subfield as the approximate value to the temperature to the microprocessor 101 via the temperature detector 103. In comparison with the first embodiment, the present embodiment uses the integrated value of the display load factor of the high-order subfield in place of the temperature. The microprocessor 101 outputs the correction coefficient to the display line luminance difference corrector 102, in accordance with the line display load factor and the integrated value of the display load factor of the high-order subfield. The display line luminance difference corrector 102 corrects the display data based on the correction coefficient. Backed by this, the luminance difference between the display lines can be prevented.

### Fifth Embodiment

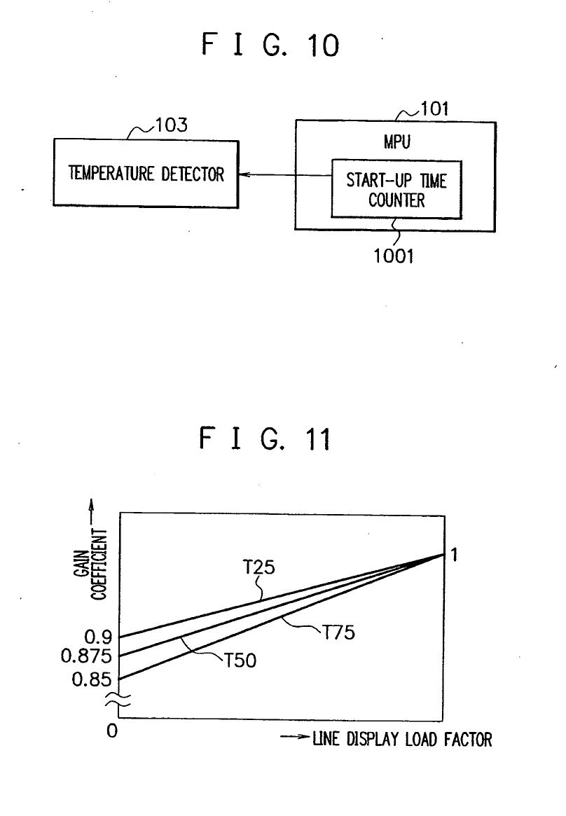

FIG. 10 is a view showing an example configuration of a microprocessor 101 and the temperature detector 103 according to a fifth embodiment of the present invention. The microprocessor 101 includes a start-up time counter 1001. The start-up time counter 1001 counts the start-up time from a power on. The temperature increases as the start-up time from the power on increases. The start-up time from the power on can, therefore, be expressed by the approximate value to the temperature.

The start-up time counter 1001 outputs the start-up time from the power on as the approximate value to the temperature to the temperature detector 103. In comparison with the first embodiment, the present embodiment uses the start-up time from the power on in place of the temperature. The microprocessor 101 outputs the correction coefficient to the display line luminance difference corrector 102, in accordance with the line display load factor and the start-up time. The display line luminance difference corrector 102 corrects the display data based on the correction coefficient. Backed by this, the luminance difference between the display lines can be prevented.

### Sixth Embodiment

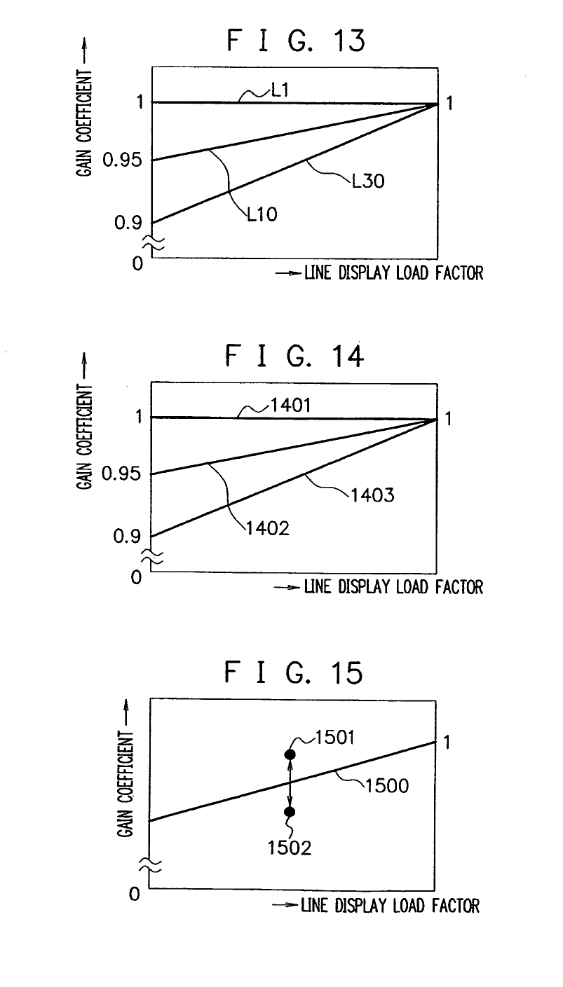

FIG. 13 is a graph showing a relation between the line display load factor, the display load factor of the single field and the gain coefficient. A sixth embodiment of the present invention calculates the gain coefficient according to the characteristics in FIG. 13. Hereinafter, the description will be given of difference between the present embodiment and the first embodiment. The vertical axis in FIG. 13 shows the gain coefficient S312 in FIG. 3. The horizontal axis shows the line display load factor. A characteristic line L1 is the characteristic line when the display load factor of the single field is 1%. A characteristic line L10 is the characteristic line when the display load factor of the single field is 10%. A characteristic line L30 is the characteristic line when the display load factor of the single field is 30%. The calculation method of the display load factor of the single field is the same as in the third embodiment.

As in the characteristic line L1, when the display load factor of the single field is low, there is little luminance difference between the display lines for the pixels of the same gray scale. On the other hand, as in the characteristic line L30, when the display load factor of the single field is high, there is large luminance difference between the display lines for the pixels of the same gray scale. In the present embodiment, when the display load factor of the single field is small as in the characteristic line L1, the luminance difference between the display lines is small, so that the gain correction is performed in accordance therewith. On the other hand, when the display load factor of the single field is high as in the characteristic line L30, the luminance difference between the display lines is large, so that the gain correction is performed in accordance therewith.

In comparison with the first embodiment, the present embodiment uses the display load factor of the single field in place of the temperature. The display load factor of the single field is obtained in the same manner as in the display load factor detecting circuit 801 in the third embodiment. The microprocessor 101 outputs the gain coefficient to the display line luminance difference corrector 102, in accordance with the line display load factor and the display load factor of the single field, as shown in FIG. 13. The display line luminance difference corrector 102 corrects the display data based on the gain coefficient. Backed by this, the luminance difference between the display lines can be prevented.

### Seventh Embodiment

In a seventh embodiment according to the present invention, an example in which constant power control is performed will be described. First, a relation between the display load factor and a sustain discharge power in the sustain time period Ts will be described. When the sustain pulse number of each subfield is assumed to be fixed, the sustain discharge power increases as the display load factor increases. Where, when the display load factor is larger than the predetermined value, the sustain pulse number is controlled so that the electric power becomes constant to prevent power increase. In concrete terms, when the display load factor becomes larger than the predetermined value, the sustain pulse number is reduced. As a result, when the display load factor is larger than the predetermined value, the electric power becomes constant.

FIG. 14 is a graph showing a relation between the line display load factor, a sustain pulse waveform and the gain coefficient. A characteristic line 1401 corresponds to the characteristic line L1 in FIG. 13 and is the characteristic line when a first sustain pulse waveform is supplied to the plasma display panel 3 when the display load factor of the single field is 1%. A characteristic line 1402 corresponds to the characteristic line L10 in FIG. 13 and is the characteristic line when a second sustain pulse waveform is supplied to the plasma display panel 3 when the display load factor of the single field is 10%. A characteristic line 1403 corresponds to the characteristic line L30 in FIG. 13 and is the characteristic line when a third sustain pulse waveform is supplied to the plasma display panel 3 when the display load factor of the single field is 30%. As described above, by the constant power control, the first sustain pulse waveform of the characteristic line 1401 is larger than the second sustain pulse waveform of the characteristic line 1402 in view of the sustain pulse number, and the third sustain pulse waveform of the characteristic line 1403 is smaller than the second sustain pulse waveform of the characteristic line 1402 in view of the sustain pulse number.

For instance, the microprocessor 101 and the driving circuit control unit 104 control the sustain purse number of the sustain pulse waveform (voltage waveform), which is to be supplied to the plasma display panel 3, in accordance with the display load factor as described above. In comparison with the first embodiment, the present embodiment uses the sustain pulse number of the sustain pulse waveform in place of the temperature. The microprocessor 101 outputs the gain coefficient to the display line luminance difference corrector 102, in accordance with the line display load factor and the sustain pulse number of the sustain pulse waveform, as shown in FIG. 14. The display line luminance difference corrector 102 corrects the display data based on the gain coefficient. Backed by this, the luminance difference between the display lines can be prevented.

### Eighth Embodiment

FIG. 15 is a graph showing a relation between the line display load factor, deviation of the display data (deviation) in each display line and the gain coefficient. An eight embodiment of the present invention calculates the gain coefficient based on the characteristics in FIG. 15. Hereinafter, the description will be given of difference between the present embodiment and the first embodiment. The vertical axis in FIG. shows the gain coefficient S312 in FIG. 3. The horizontal axis shows the line display load factor. A characteristic line 1500 is the characteristic line when the deviation of the display data in each display line is a standard value.

A characteristic point 1501 is the characteristic point when all the pixels in the display line are at the halfgray scale (for example, the halfgray scale 128 of the 256 tones) and when the display load factor of the display line is 50%. In this case, the maximum display data and the minimum display data in the display line is 128, in which such a deviation of the display data in the display line that indicates the difference between the maximum and minimum display data is extremely small. In this case, the deviation of the display data is small, in which the luminance difference between the display lines becomes small.

A characteristic point 1502 is the characteristic point when a half of the pixels in the display line are at the maximum gray scale (for example, 255) and the remaining half pixels are at the minimum gray scale (for example, 0 (zero)), and the display load factor of the display line is 50%. In this case, the maximum display data in the display line is 255 and the minimum display data in the display line is 0 (zero), in which such a deviation of the display data in the display line that indicates the difference between the maximum and minimum display data is extremely large. In this case, the deviation of the display data is large, in which the luminance difference between the display lines becomes large.

In comparison with the first embodiment, the present embodiment further uses the deviation of the display data in each display line. The microprocessor 101 outputs the gain coefficient to the display line luminance difference corrector 102, in accordance with the line display load factor, the temperature and the deviation of the display data in each display line as shown in FIG. 15. The display line luminance difference corrector 102 corrects the display data based on the gain coefficient. Backed by this, the luminance difference between the display lines can be prevented.

Also, it is acceptable that the microprocessor 101 outputs the gain coefficient to the display line luminance difference corrector 102 in accordance with the temperature and the deviation of the display data in each display line. In other words, the present embodiment can prevent the luminance difference between the display lines by correcting the display data in accordance with the temperature and the display content of each display line. The display content of the above-described each display line is, for example, the above-described line display load factor and/or the deviation of the display data in each display line.

As has been described in the above, the plasma display devices according to the first to eighth embodiments include the plasma display panel 3 composed of the plurality of pixels arranged in a matrix manner and are driven by the X-electrode and the Y-electrode that are common for plural pixels for each line. The pair of X-electrode and Y-electrode in the plasma display panel 3 is driven separately for each line. The luminance difference between the display lines can be prevented by correcting the display data by the display line luminance difference corrector 102. The above-described embodiments can reduce or eliminate the luminance difference caused between the display lines based on the extremely simple circuit 102 without requiring any additional driving circuit.

The luminance difference between the display lines can be reduced based on the simple circuit with out the need of the additional driving circuit.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display panel including a screen with plural display lines, comprising:
a temperature detector which detects a temperature of at least a portion of the plasma display panel; and
a display data adjustor which adjusts a line display data for one of the plural display lines, based on the detected temperature and information generated from each of the line display data.

2. A plasma display panel according to claim 1,
wherein the information generated from each of the line display data is information with respect to a line display load factor of the one of the plural display lines.

3. A plasma display panel according to claim 1,
wherein the information generated from each of the line display data is a line display load factor of the one of the plural display lines.

4. A plasma display panel according to claim 1,
wherein the display data adjustor adjusts the line display data by controlling a gain of the line display data.

5. A plasma display panel according to claim 1,
wherein the display data adjustor adjusts the line display data by gamma-correcting the line display data.

6. A plasma display panel according to claim 2,
wherein the display data adjustor adjusts the line display data to increase luminance of the display line depending on an increase of the line display load factor.

7. A plasma display panel according to claim 6,
wherein the display data adjustor adjusts an increase rate of luminance of the display line depending on the temperature.

8. A plasma display panel according to claim 4,
wherein the gain increases depending on an increase of the line display load factor.

9. A plasma display panel according to claim 8,
wherein a gain of a larger line display load factor is larger than a gain of a smaller line display load factor.

10. A plasma display panel according to claim 4,
wherein an increase rate of the gain increases depending on an increase of the temperature.

11. A plasma display panel according to claim 10,
wherein an increase rate of a higher temperature is larger than an increase rate of a lower temperature.

12. A plasma display panel according to claim 1,
wherein the temperature detector detects a temperature of one of scan electrode, a sustain electrode and the plasma display panel.

13. A plasma display panel according to claim 4,
wherein the gain has a linear characteristic with respect to the display load factor of the display line.

14. A plasma display panel according to claim 4,
wherein the gain has a non-linear characteristic with respect to the display load factor of the display line.

15. A plasma display panel according to claim 4,
wherein the gain changes from a linear characteristic to a non-linear characteristic with respect to the display load factor as the temperature increases.

16. A plasma display panel according to claim 4,
wherein the gain has a non-linear characteristic with respect to the display load factor of the display line, and the non-linear characteristic has a larger change rate per unit of time as the temperature increases.

17. A plasma display panel including plural display lines which displays an image in a single field having plural subfields utilizing display data, comprising:
a display load factor detector which detects a display load factor of one of the single field and at least some of the subfields included in the single field; and
a display data adjustor which adjusts a line display data for one of the plural display lines, based on the detected display load factor and information generated from each of the line display data.

18. A plasma display panel according to claim 17,
wherein the information generated from each of the line display data is information with respect to a line display load factor of the one of the plural display lines.

19. A plasma display panel including a screen with plural display lines, comprising:
an elapsed time detector which detects an elapsed time from the supply of power for the display panel; and
a display data adjustor which adjusts a line display data for one of the plural display lines, based on the detected elapsed time and information generated from each of the line display data.

20. A plasma display panel according to claim 19,
wherein the information generated from each of the line display data is information with respect to a line display load factor of the one of the plural display lines.
